(19) United States
(12) Patent Application Publication
(10) Pub. No.: US 2006/0153762 A1
(43) Pub. Date: Jul. 13, 2006

(54) Novel anion-exchange materials

(76) Inventors: Darren Frank Lee, Liverpool (GB); Keith Campbell Franklin, Cheltenham (GB); Craig Denver Williams, Shropshire (GB); Xue Song Han, Wolverhampton (GB)

Correspondence Address: MYERS BIGEL SIBLEY & SAJOVEC, PO BOX 37428, RALEIGH, NC, 27627, US

(21) Appl. No.: 10/528,918

(22) PCT Filed: Sep. 29, 2003
(86) PCT No.: PCT/GB03/04192

§ 371 Date: Oct. 3, 2005

(30) Foreign Application Priority Data
Sep. 27, 2002 (GB) 0222477.2

(51) Int. Cl. B01J 27/182; C01B 15/16

(52) U.S. Cl. 423/305; 502/214

(57) ABSTRACT

The invention provides a microporous material which comprises a positively charged framework and can be utilized as an anion exchange material, typically in the treatment of waste materials in effluent streams, for example in the nuclear power industry. The microporous material facilitates the removal of undesirable anion species from solutions. One embodiment can include a silicophosphate comprising tetrahedra of PO₄⁺ and SiO₄. A method for the synthesis of a silicophosphate using a two-phase system which includes an organic phase comprising an organosilicon compound and an aqueous phase comprising a phosphoric acid is also provided.

The present invention is concerned with new ion-exchange materials and methods for their preparation and use. Specifically, it relates to microporous materials, more particularly microporous silicophosphates, having potential application as anion-exchange materials.

Zeolites which function as molecular sieves are well known from the prior art. Typically, these materials comprise crystalline aluminosilicates having a 3-dimensional framework linked by corner-sharing oxygen atoms. They are microporous solids having pores which are generally of the size of molecular dimensions, typically in the range from 0.4 to 0.8 nm. Other examples of molecular sieves include crystalline aluminophosphates and their derivatives, such as the silicoaluminophosphates. These materials are all characterised by the fact that the crystalline framework bears a negative charge, this being balanced by the equal and opposite positive charge of a metal or other cation, such as ammonium or hydrogen.

The existence of naturally occurring zeolites has been known since the 18^{th} century, but the first synthetic samples only appeared during the mid-20^{th} century, when the properties of these materials first came under scrutiny. In addition to their use as molecular sieves, zeolites and other microporous materials have also been employed in catalysis. Thus, for example, the use of silicoaluminophosphates as catalysts for cracking, alkylation, polymerisation, hydrogenation and the like, as well as their function as molecular sieves for purposes such as drying, is disclosed in EP-B-103117. Catalytic applications such as this make use of the acidity or basicity of the material, the nature of this property being determined by the nature of the cation; thus, hydrogen ions give rise to acidity in the structure, whereas the presence of, for example, caesium cations provides a basic product.

The structures of known zeolites are based on anionic crystalline frameworks that are charge balanced with metal cations such as Na⁺; thus, for example, aluminium silicates comprise tetrahedra of AlO₄⁻ and SiO₄. These negatively charged frameworks, coupled with their open pore structures, have rendered such molecules particularly suitable as cation exchange materials, and their application in this area has been widely reported in many spheres of activity, including waste treatment and the disposal of radioactive materials. Thus, the preparation of certain metal-containing silicoaluminophosphates, and their use as cation exchangers is disclosed in, for example, EP-A-1142833.

To date, however, no positively charged zeolites, or similar microporous materials, which might potentially find application as anion exchange materials, have been reported in the literature, and there is no evidence of such products ever having been successfully synthesised. The present invention, therefore, seeks to overcome the previous limitations of the prior art and to provide microporous materials having a positively charged framework which can thereby act as anion exchange materials.

The present inventors have, indeed, now found that by judicious selection of the components of the molecule, it is possible to synthesise microporous materials which serve as molecular sieves and bear a positive charge. Such materials may be utilised as anion exchange materials, and could, therefore, find significant use in a potentially wide variety of different applications.

Thus, according to a first aspect of the present invention, there is provided a microporous material which comprises a positively charged framework.

A particularly preferred structure for providing said positively charged framework comprises a silicophosphate structure. Said silicophosphate structure comprises tetrahedra of PO₄⁺ and SiO₄ and the framework thereby bears a positive charge. Consequently, it is necessary to provide a negatively charged species to charge balance the structure, giving the potential for use as an anion exchange material.

Furthermore, it is found that the silicophosphate materials are highly crystalline solids, shown by X-ray diffraction studies to have the same framework structure as AlPO₄-15 and a framework density in the range of 12.5 to 20.5, which is typical of zeolite materials. Consequently, the materials have suitable physical and electrical characteristics for use as anion exchange materials.

Hence, a second aspect of the present invention provides for the use of a microporous material which comprises a positively charged framework as an anion exchange material.

Typical applications of microporous materials in this context are in the treatment of waste materials in effluent streams, facilitating the removal of undesirable anion species from solutions. A specific example of a particularly useful application is in the treatment of effluent streams encountered in the nuclear power industry, wherein anions such as pertechnetate, as well as the more commonly encountered nitrate and sulphate, may be removed from the streams.

Previous ion exchange techniques for the removal of such anions had usually relied on organic anion exchange materials, such as A100 Puralite™ or Superlig™ 635, which are inevitably more difficult and expensive to synthesise and offer more potential toxicity and environmental problems. Hence the availability of a relatively cheap and easily synthesised inorganic anion exchange resin represents a significant advance in the state of the art and offers many possibilities for the future.

A third aspect of the present-invention-provides a method for the synthesis of a microporous material which comprises a positively charged framework, wherein said microporous material comprises a silicophosphate, said method comprising:
(a) providing a two-phase system comprising:
   (i) an organic phase comprising an organosilicon compound;
   (ii) an aqueous phase comprising a phosphoric acid;
   (iii) a phase transfer agent;
   (iv) a structure directing agent; and
   (v) a buffering agent;
(b) stirring and facilitating reaction between the reactants; and
(c) isolating the product.

Preferably the organic phase comprises an alcoholic phase, a preferred alcohol being t-butanol or isoamyl alcohol. The organosilicon compound may be any organosilicon compound which contains a suitable labile group capable of reaction with the phosphoric acid. Specific examples may include tetramethylsilyl halides such as tetramethylsilyl chloride or tetramethylsilyl bromide.

The aqueous phase comprises a phosphoric acid, most preferably metaphosphoric acid or polyphosphoric acid.

Any suitable phase transfer agent of the type known to those skilled in the art may be employed for the purposes of the invention, but particularly effective results are obtained using organic sulphonate salts, for example toluene-4-sulphonate salts such as sodium toluene-4-sulphonate. Materials such as these are able to provide charge compensation as well as functioning as charge transfer agents.

Suitable structure directing agents preferably comprise cations such as tetraalkyl ammonium cations from tetraalkyl ammonium salts such as tetraethyl ammonium chloride or bromide.

The system also incorporates a suitable buffering agent, for example an ammonium salt such as ammonium acetate.

The reaction proceeds at a temperature of between 0° and 100° C., preferably between 20° and 70° C., most preferably between 40° and 60° C. for a duration of between 30 minutes and 12 hours, preferably between 2 and 10 hours, most preferably between 6 and 8 hours. The duration of the reaction provides a balance between allowing the silicon to be delivered slowly from the organic phase into the molecular framework of the microporous material, thereby minimising the possibility of forming a dense framework which would be impenetrable and of no value as an anion exchange material, and the economic demands of speed and efficiency of reaction.

The thus formed microporous material is most conveniently isolated from the reaction mixture by filtration, and is then washed and dried ready for use. Thus, the method of the present invention offers a convenient and reliable technique for the preparation of the microporous materials which comprise a positively charged framework, and thereby offers a means for the preparation of inorganic anion exchange materials having potential applicability across a wide range of industries, specifically in the field of waste treatment and effluent disposal.

The method of the present invention allows for the preparation of silicon phosphate in 90% yield, and shown by X-ray fluorescence spectroscopy to have the elemental composition SiPO₄.

1. A microporous material which comprises a positively charged framework comprising a silicophosphate structure.

2. The microporous material of claim 1 having a framework density in the range of 12.5to 20.5.

3. The microporous material of claim 1 wherein said microporous material is utilized as an anion exchange material.

4. The microporous material of claim 3 wherein said anion exchange material is utilized in the treatment of waste materials in effluent streams.

5. The microporous material of claim 4 wherein the microporous material is utilized in the removal of undesirable anion species from solutions in the nuclear power industry.

6. The microporous material of claim 5 wherein the anion species comprises pertechnetate anions.

7. A silicophosphate for use as an anion exchange material.

8. An anion exchange material which comprises a silicophosphate.

9. A method for the synthesis of a microporous material which comprises a positively charged framework, wherein said microporous material comprises a silicophosphate, said method comprising:
(a) providing a two-phase system comprising:
(i) an organic phase comprising an organosilicon compound;
(ii) an aqueous phase comprising a phosphoric acid;
(iii) a phase transfer agent;
(iv) a structure directing agent; and
(v) a buffering agent;
(b) stirring and facilitating reaction between the reactants; and
(c) isolating the product.

10. The method according to claim 9 wherein said organic phase comprises an alcoholic phase.

11. The method according to claim 10 wherein said alcoholic phase comprises t-butanol or isoamyl alcohol.

12. The method according to claim 9, wherein said organosilicon compound contains a labile group capable of reaction with phosphoric acid.

13. The method as claimed in claim 12 wherein said organosilicon compound comprises a tetramethylsilyl halide.

14. The method according to claim 13 wherein said tetramethylsilyl halide comprises tetramethylsilyl chloride or tetramethylsilyl bromide.

15. The method according to claim 9, wherein said phosphoric acid comprises metaphosphoric acid or polyphosphoric acid.

16. The method according to claim 9, wherein said phase transfer agent comprises an organic sulphonate salt.

17. The method according to claim 16 wherein said organic sulphonate salt comprises a toluene-4-sulphonate salt.

18. The method according to claim 17 wherein said toluene-4-sulphonate salt comprises sodium toluene-4-sulphonate.

19. The method according to claim 9, wherein said structure directing agent comprises cations.

20. The method according to claim 19 wherein said cations comprise tetraalkyl ammonium cations.

21. The method according to claim 9, wherein said structure directing agent comprises tetraethyl ammonium chloride or tetraethyl ammonium bromide.

22. The method according to claim 9, wherein said buffering agent comprises an ammonium salt.

23. The method according to claim 22 wherein said ammonium salt comprises ammonium acetate.

24. The method according to claim 9, which proceeds at a temperature of between 0° and 100° C.

25. The method according to claim 24 which proceeds at a temperature of between 20° and 70° C.

26. The method according to claim 25 which proceeds at a temperature of between 40° and 60° C.

27. The method according to claim 9 which proceeds for a duration of between 30 minutes and 12 hours.

28. The method according to claim 27 which proceeds for a duration of between 2 and 10 hours.

29. The method according to claim 28 which proceeds for a duration of between 6 and 8 hours.

30. The method according to claim 9, wherein the microporous material is isolated from the reaction mixture by filtration.
